(19) United States
(12) Patent Application Publication
(10) Pub. No.: US 2022/0092547 A1
(43) Pub. Date: Mar. 24, 2022

(54) SYSTEM, METHOD, AND COMPUTER PROGRAM FOR PROCESSING COMPENSATION DATA

(71) Applicant: Eightfold AI Inc., Santa Clara, CA (US)

(72) Inventors: Ashutosh Garg, Sunnyvale, CA (US); Ruoyu Roy Wang, Santa Clara, CA (US)

(73) Assignee: Eightfold AI Inc., Santa Clara, CA (US)

(21) Appl. No.: 17/478,750

(22) Filed: Sep. 17, 2021

Related U.S. Application Data
(60) Provisional application No. 63/080,584, filed on Sep. 18, 2020.

(51) Int. Cl. G06Q 10/10; G06N 3/04

(52) U.S. Cl. CPC G06Q 10/1053; G06N 3/0454

(57) ABSTRACT

A system and method for implementing a talent management platform to determine, from a pool of applicants to a job opening, matching candidates, determine, using a neural network module, a set of feature values from the one or more feature values contained in the talent profiles associated with the matching candidates, generate a query based on the set of feature values, retrieve, based on the query, compensation data from a compensation database, and present, in a user interface, the compensation data as part of potential offers to the matching candidates.

### CROSS-REFERENCE TO RELATED APPLICATIONS

This application claims the priority benefit of U.S. Provisional Application 63/080,584 filed Sep. 18, 2020.

### TECHNICAL FIELD

The present disclosure relates to a data-driven talent management platform, and in particular to a system, method, and computer program for processing compensation database and for presenting the processed compensation data.

### BACKGROUND

An organization may be composed of units of employees. The organization can be a company, a nonprofit organization, or a government agency. The units of employees may include a division, a department, a team, a group of employees associated with a project, or any combinations of employees grouped together for one or more common objectives or defined by one or more common characteristics. The employees of the organization may include experienced and new employees.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates a computing system implementing a talent management platform including components to manage compensation related information according to an implementation of the disclosure.

FIG. 2 illustrates a machine learning module that may be used to determine matching candidates based on a job profile characterizing a job opening and talent profiles of applicants to the job opening according to an implementation of the disclosure.

FIG. 3 illustrates a flowchart of a method for determining a set of feature values for extracting compensation data according to an implementation of the disclosure.

FIG. 4 illustrates a flowchart of a method for determining a compensation range based on historical compensation trends according to an implementation of the disclosure.

FIG. 5 illustrates a flowchart of a method for managing the compensation of workforce according to an implementation of the disclosure.

FIG. 6 depicts a block diagram of a computer system operating in accordance with one or more aspects of the present disclosure.

### DETAILED DESCRIPTION

The workforce of the organization may include employees and contractors that may be collectively referred to as talents of the organization. The organization may use an intelligent talent management platform to manage different aspects of its pool of talents or the workforce. The intelligent talent management platform may include computing resources such as computer systems or cloud computing systems that may be programmed to implement machine learning models (e.g., any suitable types of neural networks) to make unbiased decisions based on data. The different aspects may include talent acquisition, talent retain, talent training, and talent development. Employee compensation plays an important role in all of these aspects.

Compensation to an employee in this disclosure refers to the financial rewards that the organization offers to or pays the employee according to an employment agreement in exchange for the employee's employment with the organization. The compensation may include different components such as salary, wage, bonus, and shares or derivatives of the shares of the organization, as well as different forms of fringe benefits such as retirement plans and medical insurance policies paid by the organization.

An organization commonly wishes to provide compensations that are competitive in the job market for the purposes of talent acquisition and talent retention. To this end, the organization may wish to derive insights from market compensation data to promote a fair and balanced compensation practice within the organization. Insights into accurate compensation information in the job market may help the organization attract new talents and retain the best existing talents. The compensation data may include salaries, bonuses, and equity information as related to different characterization aspects of the employment including specific roles, specific types of roles, and units within the organization. Examples of roles may include job titles such as executives, managers, and analysts. Each role may be associated with a compensation band corresponding to a seniority level within the organization. The seniority levels may be identified by a numerical representation such as T1-T12 with the T1 as the highest ranking. Such compensation data may be compiled across various companies within a particular industry or across industries. The compensation data may also be compiled according to organization types such as public versus private at varying sizes. To provide a meaningful insight for a particular hiring situation, a human resource (HR) manager traditionally needs to look up and filter market compensation reports based on manual review of applicable dimensions using his or her personal judgment to arrive at a filtered set of data points. It is a challenge for the HR manager to apply proper filters that identifies relevant compensation data in a limited amount of time. In this scenario, the filtered results are typically derived in a small sample size that may be statistically unbalanced (e.g., skewed towards a certain sector of companies). This could lead to inaccurate portrayal of compensation data for a given role with respect to a given candidate that the organization wants to attract. Additionally, the filtered results generated by applying filters handcrafted by the HR manager may also include personal bias (e.g., explicit or implicit bias by the HR manager) and may subject to subjective errors.

Implementations of the disclosure provide for a talent management platform that includes a compensation management component implementing a system and method on a hardware processing device for examining, organizing, and presenting relevant compensation information that is derived using machine learning models based on a deep understanding of the company's talent pool and job positions. The deep understanding helps an organization objectively and systematically identify the relevant compensation data to the HR manager so that the HR manager may provide the right compensation solutions in a data-driven approach, thus achieving competitive talent acquisition in a job market and the retention of existing employees based on competitive and fair compensations.

Implementations of the disclosure includes a computing system implementing a talent management platform. The computer system includes a memory device, and one or more processing devices, communicatively connected to the memory device, to determine, from a pool of applicants to a job opening, a plurality of matching candidates, wherein each of the plurality of candidates is characterized by a corresponding talent profile comprising one or more feature values, and wherein the job opening is characterized by a job profile comprising job requirements; determine, using a neural network module, a set of feature values from the one or more feature values contained in the talent profiles associated with the plurality of matching candidates; generate a query based on the set of feature values; retrieve, based on the query, compensation data from a compensation database; and present, in a user interface, the compensation data as part of potential offers to the plurality of matching candidates.

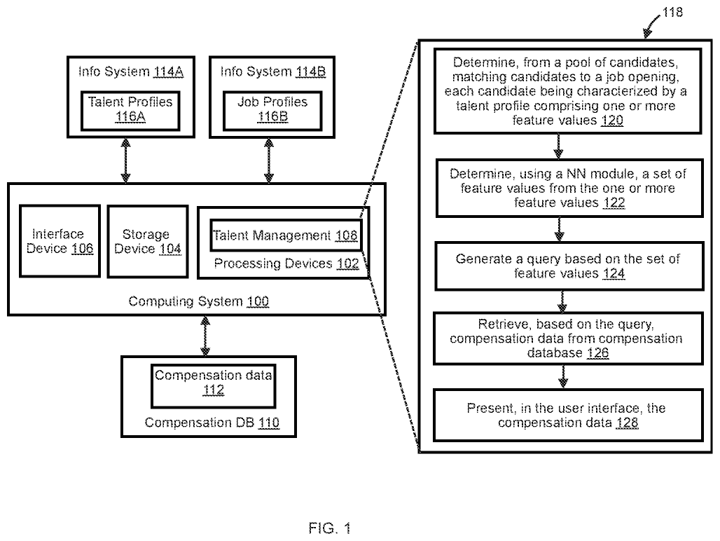

FIG. 1 illustrates a computing system 100 implementing a talent management platform 108 including components to manage compensation related information according to an implementation of the disclosure. Computing system 100 can be a standalone computer or a networked computing resource implemented in a computing cloud. Referring to FIG. 1, computing system 100 may include one or more processing devices 102, a storage device 104, and an interface device 106, where the storage device 104 and the interface device 106 are communicatively coupled to processing devices 102.

A processing device 102 can be a hardware processor such as a central processing unit (CPU), a graphic processing unit (GPU), or an accelerator circuit. Interface device 106 can be a display such as a touch screen of a desktop, laptop, or smart phone. Storage device 104 can be a memory device, a hard disc, or a cloud storage connected to processing device 102 through a network interface card (not shown).

Processing device 102 can be a programmable device that may be programmed to implement a graphical user interface presented on interface device 106. The interface device may include a display screen for presenting textual and/or graphic information. Graphical user interface (“GUI”) allows a user using an input device (e.g., a keyboard, a mouse, and/or a touch screen) to interact with graphic representations (e.g., icons) presented on GUI.

Computing system 100 may be connected to other information systems 110, 114A, 114B through a network (not shown). These information systems can be human resource management (HRM) systems that are associated with one or more organizations that hire or seek to hire employees to form their workforces (referred to as “talents”). The HRM systems can track external/internal candidate information in the pre-hiring phase (e.g., using an applicant track system (ATS)), or track employee information after they are hired (e.g., using an HR information system (HRIS)). Thus, these information systems may include databases that contain information relating to candidates and current employees.

Referring to FIG. 1, information system 114A can be an HRM system of an organization that may desire to hire new employees or retain existing employees with competitive and fair compensation. Information system 114A may include a database that stores the talent profiles 116A associated with job candidates or existing employees. Each of talent profiles 116A can be a data object that contains data values (referred to as feature values) related to a candidate or an employee. In this disclosure, the features can be the categories of information. Examples of features may include job title, employer, years of experience, college, postgraduate university etc. The feature values are the values associated with features or different categories. Examples of feature values may be “analyst,” “group manager,” “lab director,” “program manager” etc. as values for the “job title” feature; “1 year,” “2-4 years” etc. as values for the “years of experiences” feature. Other feature values may be similarly specified. In one implementation, talent profile 116A may include a resume. In other implementations, the talent profile 116A may include the resume and other information collected from other sources beyond the resume, and/or predicted feature values calculated based on the resume and the other information collected from other sources.

In some implementations, the talent profile 116A may be used to characterize a person (e.g., a candidate or an employee). The talent profile 116A may include feature values such as a job title currently held by the person and job titles previously held by the person, companies and teams to which the person previously belonged and currently belongs, descriptions of projects on which the person worked on, the technical or non-technical skills possessed by the person for performing the jobs held by the person, and the location (e.g., city and state) of the person. The talent profile 116A may further include other feature values such as the person's education background information including schools he or she has attended, fields of study, and degrees obtained. The talent profile 116A may further include other professional information of the employee such as professional certifications the employee has obtained, achievement awards, professional publications, and technical contributions to public forum (e.g., open source code contributions). Talent profile 116A may also include predicted feature values that indicate the likely career progress path through the organization if the person stays with the organization for a certain period of time.

Computing system 100 may be connected to information systems 114B of an organization that may be in the job market to hire employees to fill job openings of the organization. Information system 114B may include job profiles 116B associated with job openings. Each job profile may specify different job requirements desired from candidates to fill the corresponding job opening. In one implementation, a job profile may include job requirements such as job titles, teams to which the hire belongs to, projects on which the hire works, job functions, required experiences, requisite education/degrees/certificates/licenses etc. The job profiles may also include desired personality traits of the candidates such as leadership attributes, social attributes, and altitudes. In addition to these explicit requirements that can be specified in a textual description, a job profile may also include the talent profiles of employees that had been hired for the same or similar positions and the talent profiles of candidates that the organization considered to hire. These talent profiles may contain information that can be uncovered in the machine learning module.

Talent management platform 108 may be implemented as an application on computer system 100. The talent management platform 108 is designed to enable the human resource (HR) department of the organization to efficiently and effectively manage the workforce. One important aspect of talent management is to manage the compensation of the workforce. The compensation in this disclosure refers to the combination of different forms of monetary rewards the organization pays to or offers to a person (e.g., an employee or a candidate) in exchange for the person's employment with the organization. The compensation may include the salary/wage, bonus, and equity (e.g., stock shares of a company or options to the stock shares of the company). Additionally, the compensation may include other forms of rewards including, for example, paid insurance policies (e.g., medical insurance, life insurance, disability insurance etc.), retirement plans (e.g., matched 401(k)/403(b) plans), pension plans, paid vacation days, paid childcares, and other fringe benefits. Competitive compensations play an important role in attracting qualified job candidates, converting matching candidates to new hires, and retaining employees to stay with the organization.

In one implementation, computer system 100 may be connected to a compensation database 110 that stores compensation data 112 collected and compiled from public or proprietary sources. The compensation data 112 stored in compensation database 110 may include entries containing compensations (e.g., salaries, bonuses, equities, fringe benefits, and/or a total compensation value or a sum of different forms of rewards) and feature values such associated with the compensations. The feature values may include job titles, descriptions of the jobs, years of experience, education levels etc. These feature values can be used by a search engine to search, filter, and index the compensation data. Thus, a HR manager may access the content or the compensation data by manually constructing a filter (e.g., a frontend programmer with 4-6 years of experience) and retrieve filtered compensation data from compensation database 110. As discussed above, this approach has certain disadvantages such as it is subject to human bias (either explicit or implicit), and it may be inconsistence across the spectrum of HR managers in the HR department because it is driven by each HR manager's individual experience rather than by data. To overcome these practical problems in talent management, implementations of the disclosure provide technical solutions that include one or more neural network modules that are used to intelligently and efficiently retrieve compensation data from compensation database 110. The retrieved compensation data are selected based on a data-driven approach, thus reducing human bias and being consistent across the organization. Further, talent management platform 108 according to implementations of the disclosure may allow an HR manager to determine the proper compensation level to a candidate or an existing employee in real time.

In one implementation, talent management platform 108 may include a compensation management component 118 that can be a software application executed by processing devices 102. In one implementation, processing devices 102 may execute the compensation management component 118 to assist an HR manager in determining a proper compensation (i.e., a compensation that is competitive in the job market and is fair to the candidate) for a candidate in a hiring process. To this end, the processing devices 102 may determine, from a pool of applicants to a job opening, matching candidates. An organization may desire to fill a job opening. The job opening that may be characterized by a job profile 116B that may be stored in information system 114B. As discussed above, the job 116B profile may include a description of the job and its requirements such as job titles, teams to which the hire belongs to, projects on which the hire works, job functions, required experiences, requisite education, degrees, certificates, licenses etc. Additionally, processing devices 102 may enhance the job profile 116B with additional information such as desired personality traits of the candidates such as leadership attributes, social attributes, and altitudes, as well as the talent profiles of employees that had been hired for the same or similar positions and the talent profiles of candidates that the organization considered to hire. In response to publication of the job opening, the organization may receive applicants to the job opening. Each applicant may submit a resume that may constitute part of the applicant's talent profile 116A. In addition to the feature values in the resume, processing devices 102 may further enhance the talent profile by including other feature values collected from other information sources or predicted feature values calculated based on the fact-based feature values. Thus, talent profile 116A may include feature values such as job titles currently and previously held by the applicant, companies and teams worked in, descriptions of projections worked on, the technical or non-technical skills, job locations, and education background including schools attended, fields of study, and degrees obtained. The talent profile 116A may further include other professional information of the employee such as professional certifications the employee has obtained, achievement awards, professional publications, and technical contributions to public forum (e.g., open source code contributions). In addition to these fact-based data points, the talent profile 116A may also be enriched to include derived information relating to the employee. For example, talent profile 116A may include predicted feature values that indicate the likely career progress path through the organization if the person stays with the organization for a certain period of time. The career path may indicate the potential of the person with the organization. The predicted feature values may include characteristics of the person calculated from the information pertaining to the person. These characters may include the effort level, the leadership, the velocity of skill improvement, the velocity of promotions etc.

In one implementation, the processing devices 102 may execute a neural network module to determine, from the applicants, candidates that are best matched to the job opening. The determination of the matching candidates is based on a machine learning model rather than personal preferences of each individual HR manager.

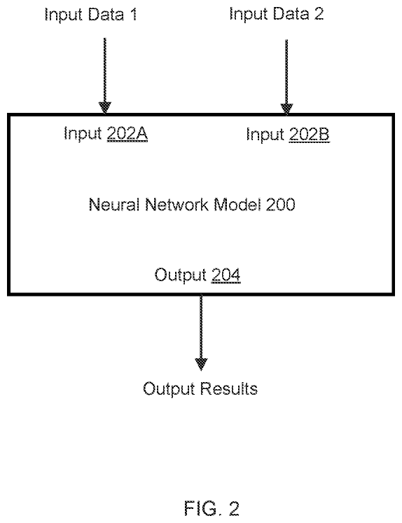

FIG. 2 illustrates a machine learning module 200 that may be used to determine matching candidates based on a job profile characterizing a job opening and talent profiles of applicants to the job opening according to an implementation of the disclosure. In one implementation, machine learning module 200 may be a deep neural network that may include multiple layers, in particular including an input layer for receiving data inputs, an output layer for generating outputs, and one or more hidden layers that each includes linear or non-linear computation elements (referred to as neurons) to perform the DNN computation propagated from the input layer to the output layer that may transform the data inputs to the outputs. Two adjacent layers may be connected by edges. Each of the edges may be associated with a parameter value (referred to as a synaptic weight value) that provide a scale factor to the output of a neuron in a prior layer as an input to one or more neurons in a subsequent layer.

Referring to FIG. 2, machine learning module 200 may include an input layer including a first input 202A to receive, as input data 1, a talent profile characterizing an applicant to the job opening. As discussed above, the talent profile is a data object including entries specifying different aspects of the applicant. The information relating to the applicant may include feature values obtained from the HR database and may also include feature values obtained from external data sources such as professional web page, publications, and professional contributions to the public domains. Thus, the talent profile of the applicant received at input 202A may include information beyond commonly available to an HR manager within the organization. Similarly, the input layer may also include a second input 202B to receive, as input data 2, a job profile characterizing the job opening to which the applicant applies for. As discussed above, the job profile received at input 202B may include, but not limited to, titles and ranking levels of jobs, and skills required to perform the jobs, a minimum number of years of working experience. The machine learning module 200 may include an output layer including output 204 to produce a matching score between the talent profile and the job profile, where the matching score is a parameter indicating how well the applicant is matched to the job opening.

In one implementation, processing devices 102 may run each of the talent profiles for applicants to the job opening through the neural network module against the job profile to obtain a corresponding matching score for the applicant. Based on the matching scores for these applicants, processing devices 102 may determine one or more matching candidates for the job based on rules. For example, the rule may be to select applicants whose matching scores are above a threshold as the matching candidates. Thus, in this way, processing devices 102 may determine matching candidates to a job opening based on data.

Machine learning using a neural network module in this disclosure refers to methods implemented on a hardware processing device that uses statistical techniques and/or artificial neural networks to give computer the ability to learn as the computer progressively improves performance on a specific task, from data without being explicitly programmed The machine learning may use a parameterized model (referred to as “machine learning module” or “neural network module”) that may be deployed using supervised learning/semi-supervised learning, unsupervised learning, or reinforced learning methods. Supervised/semi-supervised learning methods may train the machine learning modules using labeled training examples. To perform a task using supervised machine learning module, a computer may use examples (commonly referred to as “training data”) to test the machine learning module and to adjust parameters of the machine learning module based on a performance measurement (e.g., the error rate). The process to adjust the parameters of the machine learning module (commonly referred to as “train the machine learning module”) may generate a specific model that is to perform the practical task it is trained for. After training, the computer may receive new data inputs associated with the task and calculate, based on the trained machine learning module, an estimated output for the machine learning module that predicts an outcome for the task. Each training example may include input data and the corresponding desired output data, where the data can be in a suitable form such as a vector of numerical alphanumerical symbols.

The learning process of the machine learning module may be an iterative process. The process may include a forward propagation process to calculate an output based on the machine learning module and the input data fed into the machine learning module, and then calculate a difference between the desired output data and the calculated output data. The process may further include a backpropagation process to adjust parameters of the machine learning module based on the calculated difference.

In implementations of the disclosure, the training data may be constructed from historical data (e.g., prior hired employees or considered candidates for job openings). The matching score may be set based on a number of factors such as the percentage of candidates that are hired as employees for that job. A specific machine learning module 200 may be constructed through the training process using the train data set.

The above discussion relating to machine learning modules or neural network modules is for illustrative purpose without limitations. Any types of machine learning modules or neural network modules that are suitable for use may be deployed in the implementations of the disclosure, including artificial neural networks (ANN), convolution neural networks (CN), recurrent neural networks (RNN), single or multiple layer perceptron networks, Long Short-Term Memory (LSTM) networks, transformer networks etc.

Referring to FIG. 1, at 120, processing devices 102 may determine the matching candidates to the job opening using the machine learning method described above. Each of the matching candidates may be characterized by a corresponding talent profile. Each of the talent profiles of the matching may include feature values as described above. These feature values may be used in a data-driven approach to get offers to these matching candidates.

In one implementation, at 122, processing devices 102 may determine, using another neural network module and statistical methods, a set of feature values from the feature values associated with the matching candidates. The set of feature values can be a subset of all feature values associated with the matching candidates, and represent the most relevant feature values for extracting compensation data from the compensation database 110.

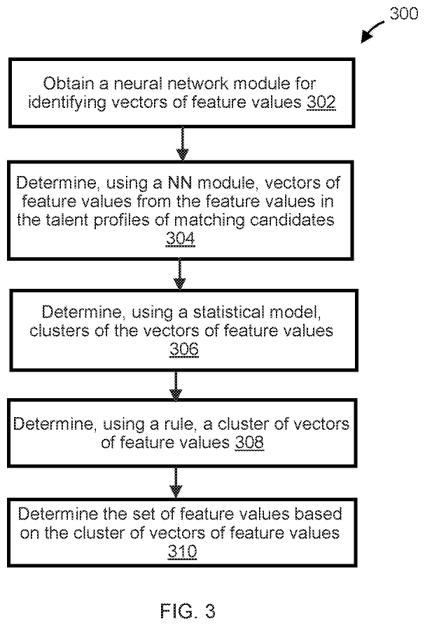

FIG. 3 illustrates a flowchart of a method 300 for determining a set of feature values for extracting compensation data according to an implementation of the disclosure. Method 300 may be performed by processing devices (e.g., processing devices 102) that may comprise hardware (e.g., circuitry, dedicated logic), computer readable instructions (e.g., run on a general purpose computer system or a dedicated machine), or a combination of both. Referring to FIG. 3, at 302, the processing devices may obtain the neural network module for determining the set of feature values. This neural network module may have different parameterization and configuration than the one used to determine matching candidates used in step 120. However, this neural network module may utilize similar topologies in the sense that it may also be a DNN with an input layer, inner layers, and an output layer, and be trained using training data. In this context, this neural network module may be trained to extract vectors of feature values contained in the talent profiles associated with matching candidates. In some scenarios, certain features contained in the talent profiles may be more relevant to determining the compensation. Such relevant features may include job title, years of experience, nature of the work, particular skills, education etc. Other features may be less relevant or irrelevant to determining the compensation. Such less relevant features may include non-technical skills, personalities etc., and the irrelevant features may include gender, age, etc. Thus, this neural network module may be trained to extract those feature values that are relevant to the compensation. The input to this neural network module can be feature values of talent profiles associated with matching candidates, and the output of this neural network module can be vectors of feature values that are relevant to the compensation.

At 304, the processing devices may determine, using this neural network module, vectors of feature values from the feature values in the talent profiles of matching candidates. The vectors of feature values are those relevant to the compensation without those less relevant or irrelevant feature values. Examples of vectors of feature values that are relevant to the compensation may include job titles held by the candidates. For each talent profile associated with a corresponding matching candidate, the processing devices may exact a vector of feature values.

These vectors of feature values may be scattered in a multidimensional feature space and is less useful in constructing a query to the compensation database 110. To overcome this problem, implementations of the disclosure may further employ a statistical analysis component to determine a set of feature values that represent the most frequently appeared relevant feature values which can be used to generate an effective query. To this end, at 306, the processing devices may determine, using a statistical model, clusters of vectors of feature values. Implementations may use a statistical clustering method (e.g., k-means) to cluster the vectors of feature values in the multidimensional feature space into clusters of vectors, where each dimension of the multidimensional feature space may correspond to a feature (e.g., job title, years of experience etc.).

Implementations may choose one or more clusters of vectors based rules. At 308, the processing devices may determine, using a rule, a cluster of vectors of feature values. The clusters determined by the statistical clustering method may be distributed in the multidimensional feature space. Some cluster may have a larger number of vectors than other clusters or may have higher density of vectors than other clusters. So, the rule used to select the cluster can be to select a certain number (e.g., 3) of the largest or densest clusters.

At 310, the processing devices may determine the set of feature values based on the cluster of vectors of feature values, where the cluster is the one selected at 308. The feature values in the cluster may be used to construct the query to the compensation database 110.

Referring to FIG. 1, at 124, processing devices 102 may generate a query based on the set of feature values. In one implementation, the query may be generated by combining the set of feature values into a super vector of feature values. In another implementation, processing devices 102 may further select the most frequently appeared feature value in the supervector as the query.

Responsive to generating the query, at 126, processing devices 102 may retrieve, based on the query, compensation data from the compensation database 110. Compensation database 110 may be configured with a search engine that may extract, filter, or retrieve relevant compensation data responsive to the query. For example, the query may be (job titles: frontend programmer, backend programmer; work experience: 4-6 years), and the responses from the compensation database 110 may be the compensation data that meet the query requirements.

At 128, processing devices 102 may present, in the user interface, the compensation data retrieved from the compensation database 110. In one implementation, the compensation data may be presented as all of the compensation data points in a table. In another implementation, statistics of the compensation data may also be presented in the user interface for the convenience to the user (e.g., the HR manager). The statistics may include the average, the mean, and curves of compensation data with respect to the feature values. In this way, implementations of the disclosure may provide compensation data to a user (e.g., an HR manager or a hiring manager) with compensation data using a data-driven approach without introducing human biases.

In some applications, the user may also need to obtain future predicted compensation data based on historical compensation data trends. For example, in a competitive hiring from a competitor organization, the hiring organization may want to know the current market compensation data and also the potential future compensation data so that the hiring organization may offer to meet the potential future compensation in luring the target competitive hire.

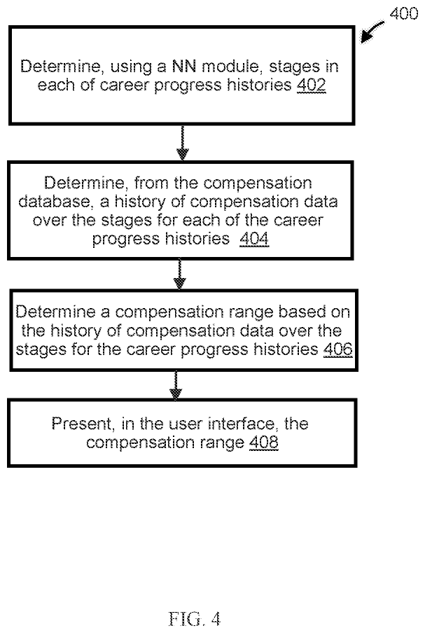

FIG. 4 illustrates a flowchart of a method 400 for determining a compensation range based on historical compensation trends according to an implementation of the disclosure. Method 400 may be performed by processing devices (e.g., processing devices 102) that may comprise hardware (e.g., circuitry, dedicated logic), computer readable instructions (e.g., run on a general purpose computer system or a dedicated machine), or a combination of both. In one implementation, the compensation database 110 may further include career progress histories for employees of an organization (e.g., the competitor organization). A career progress history may include different stages through an employee's career and the compensation for each stage. The stages may be delimited by a career event such as, for example, a job title change (representing a role change), a job skill change (representing a skill improvement), an employer change etc. The career progress history may represent a trend in the compensation and may contain information for predicting future compensation if the career progresses continuously. Referring to FIG. 4, at 402, the processing devices may determine, using another neural network module, stages in each of the career progress histories stored in the compensation database. This neural network module may be trained so that when it is executed may detect career events in the career progress histories. These events may be used as landmarks for different stages in the career.

At 404, the processing devices may determine, from the compensation database 110, a history of compensation data over the stages for each of the career progress histories. Thus, the compensations (e.g., salaries) for these stages in the career progress history may be ascertained. The stages and their corresponding compensation data may constitute a historical compensation trend for a hiring target.

At 406, the processing devices may determine a compensation range based on the history of compensation data over the stages for the career progress histories. The range may include an upper compensation bound and a lower compensation bound at one or more future time points (e.g., one year, two years, and up to five years from now). The compensation range can be a predicted band with a certain confidence that the target hire may make these amounts in the future time point.

At 408, the processing devices may present, in the user interface, the compensation range for a user to use. The user (e.g., an HR manager) may choose a compensation from the range as part of the competitive offer to the target competitive hire.

To further facilitate the HR manager, in one implementation, the processing devices may determine, using this neural network module, a probability value associated with each corresponding compensation level within the compensation range. The probability value may indicate a likelihood for target hire to accept an offer at the corresponding compensation level. The processing devices may further present, in the user interface, the compensation range comprising the compensation levels and their corresponding probability values. This implementation may further assist the HR manager to make an effective offer to the target hire.

Implementations of the disclosure may help a user obtain compensation data in real time. In one application, the HR manager may adjust certain job requirements in a job opening. Responsive to the update in the job opening, the operations 120-128 may be executed again to generate new compensation data.

In another application, implementations of the disclosure may be deployed to monitor the compensation status of current employees to ensure that the compensations are adequate in response to any career events or changes. The events or changes can be increase of responsibility, improvement of efforts, or newly added skills applied to work. In this regard, the processing devices may monitor a talent profile database stored therein talent profiles of employees of an organization. Responsive to determining a change in an employee's talent profile stored in the talent profile database, the processing devices may determine, using the neural network module, whether the employee's compensation deviates from a normal compensation range, where the normal compensation range reflects the range for the updated talent profile. Responsive to determining that the compensation of the employee deviates from the normal compensation range, the processing devices may transmit a notification to a manager account of a manager. The notification may inform the manager to consider adjusting the employee's compensation. In this way, the employee's compensation may be monitored and adjusted out of performance review cycles, thus further improving the talent management capability of the organization.

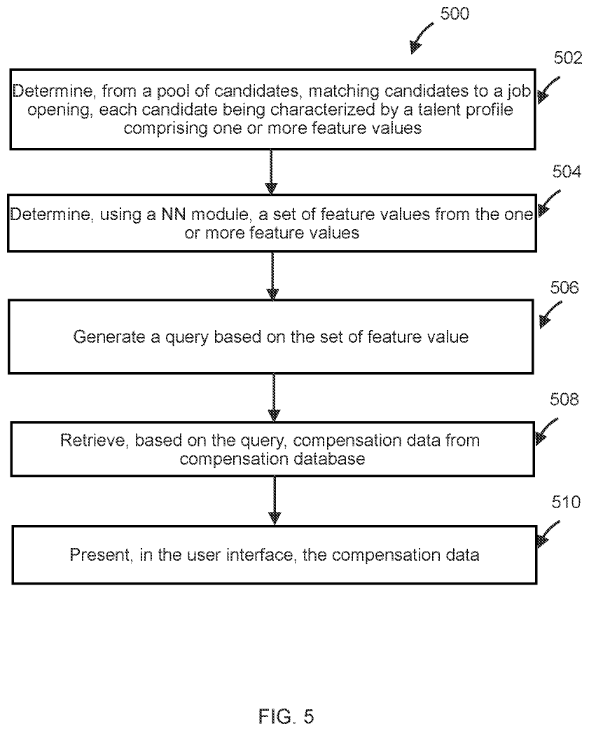

FIG. 5 illustrates a flowchart of a method 500 for managing the compensation of workforce according to an implementation of the disclosure. Method 500 may be performed by processing devices that may comprise hardware (e.g., circuitry, dedicated logic), computer readable instructions (e.g., run on a general purpose computer system or a dedicated machine), or a combination of both. Method 500 and each of its individual functions, routines, subroutines, or operations may be performed by one or more processing devices of the computer device executing the method. In certain implementations, method 500 may be performed by a single processing thread. Alternatively, method 500 may be performed by two or more processing threads, each thread executing one or more individual functions, routines, subroutines, or operations of the method.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be needed to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media. In one implementation, method 500 may be performed by processing devices 102 implementing the talent management platform 108 as shown in FIG. 1.

As shown in FIG. 5, processing devices 102 may, at 502, determine, from a pool of applicants to a job opening, matching candidates, where each of the matching candidates is characterized by a corresponding talent profile including one or more feature values, and where the job opening is characterized by a job profile including job requirements.

At 504, processing devices 102 may determine, using a neural network module, a set of feature values from the one or more feature values contained in the talent profiles associated with the matching candidates.

At 506, processing devices 102 may generate a query based on the set of feature values.

At 508, processing devices 102 may retrieve, based on the query, compensation data from a compensation database.

At 510, processing devices 102 may present, in a user interface, the compensation data as part of potential offers to the matching candidates.

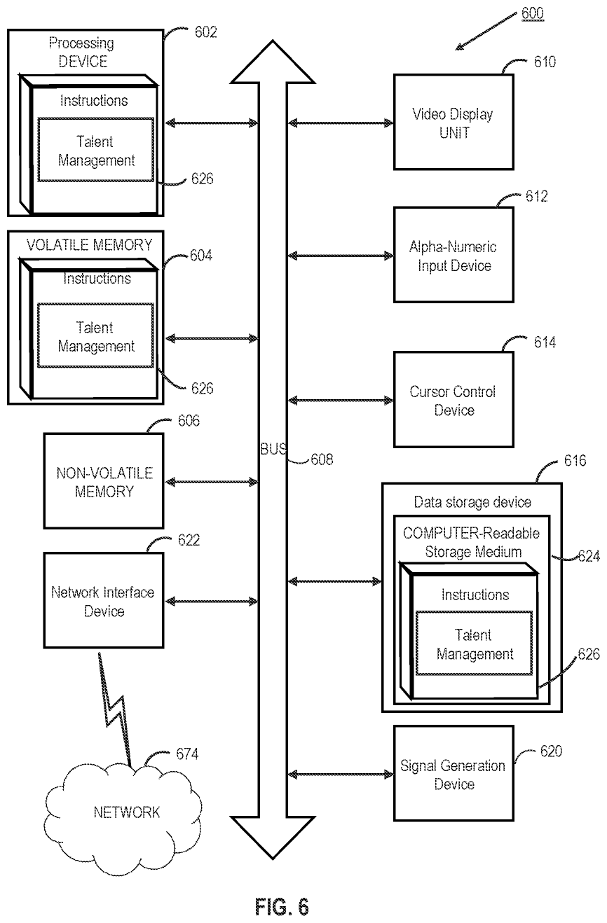

FIG. 6 depicts a block diagram of a computer system operating in accordance with one or more aspects of the present disclosure. In various illustrative examples, computer system 600 may correspond to the processing devices 102 of FIG. 1.

In certain implementations, computer system 600 may be connected (e.g., via a network, such as a Local Area Network (LAN), an intranet, an extranet, or the Internet) to other computer systems. Computer system 600 may operate in the capacity of a server or a client computer in a client-server environment, or as a peer computer in a peer-to-peer or distributed network environment. Computer system 600 may be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 600 may include a processing device 602, a volatile memory 604 (e.g., random access memory (RAM)), a non-volatile memory 606 (e.g., read-only memory (ROM) or electrically-erasable programmable ROM (EEPROM)), and a data storage device 616, which may communicate with each other via a bus 608.

Processing device 602 may be provided by one or more processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 600 may further include a network interface device 622. Computer system 600 also may include a video display unit 610 (e.g., an LCD), an alphanumeric input device 612 (e.g., a keyboard), a cursor control device 614 (e.g., a mouse), and a signal generation device 620.

Data storage device 616 may include a non-transitory computer-readable storage medium 624 on which may store instructions 626 encoding any one or more of the methods or functions described herein, including instructions of the talent management platform 108 of FIG. 1 for implementing method 500.

Instructions 626 may also reside, completely or partially, within volatile memory 604 and/or within processing device 602 during execution thereof by computer system 600, hence, volatile memory 604 and processing device 602 may also constitute machine-readable storage media.

While computer-readable storage medium 624 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and computer program components, or in computer programs.

Unless specifically stated otherwise, terms such as “receiving,” “associating,” “determining,” “updating” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and may not have an ordinal meaning according to their numerical designation.

Examples described herein also relate to an apparatus for performing the methods described herein. This apparatus may be specially constructed for performing the methods described herein, or it may comprise a general purpose computer system selectively programmed by a computer program stored in the computer system. Such a computer program may be stored in a computer-readable tangible storage medium.

The methods and illustrative examples described herein are not inherently related to any particular computer or other apparatus. Various general purpose systems may be used in accordance with the teachings described herein, or it may prove convenient to construct more specialized apparatus to perform method and/or each of its individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

What is claimed is:

1. A computing system implementing a talent management platform, the computing system comprising:
a memory device; and
one or more processing devices, communicatively connected to the memory device, to:
determine, from a pool of applicants to a job opening, a plurality of matching candidates, wherein each of the plurality of matching candidates is characterized by a corresponding talent profile comprising one or more feature values, and wherein the job opening is characterized by a job profile comprising job requirements;
determine, using a neural network module, a set of feature values from the one or more feature values contained in the talent profiles associated with the plurality of matching candidates;
generate a query based on the set of feature values;
retrieve, based on the query, compensation data from a compensation database; and
present, in a user interface, the compensation data as part of potential offers to the plurality of matching candidates.

2. The system of claim 1, wherein the one or more processors are further to:
responsive to receiving an update to the job profile characterizing the job opening, determine, from the pool of applicants to the job opening, a second plurality of matching candidates;
determine, using the machine learning model, a second set of feature values from the one or more feature values contained in the talent profiles associated with the second plurality of matching candidates;
generate a second query based on the second set of feature values;
retrieve, based on the second query, second compensation data from a compensation database; and
present, in the user interface, the second compensation data.

3. The system of claim 1, wherein the one or more feature values comprise at least one of a job title, a team identifier, a project identifier, a job skill, or an education achievement.

4. The system of claim 1, wherein the compensation database comprises compensation data compiled from one or more organizations.

5. The system of claim 1, wherein to determine, from a pool of applicants to a job opening, a plurality of matching candidates, the one or more processing devices are further to:
obtain a second neural network module, wherein the second neural network module is trained by adjusting at least one parameter associated with the second neural network module using training talent profiles, and a training job profile; and
execute the second neural network module using talent profiles associated with the pool of applicants as first inputs and the job profile as a second input to determine the plurality of matching candidates for the job opening.

6. The system of claim 1, wherein to determine, using a neural network module, a set of feature values from the one or more feature values contained in the talent profiles associated with the plurality of matching candidates, the one or more processing devices are to:
obtain the neural network module, wherein the neural network module is trained by adjusting at least one parameter associated with the neural network module using training feature values obtained from training talent profiles;
determine, using the neural network module, vectors of feature values from the one or more feature values contained in the talent profiles associated with the plurality of matching candidates;
determine, using a statistical model, one or more clusters of the vectors of feature values; and
determine, using a rule, a cluster of vectors of feature values, and determine the set of features based on the cluster of vectors of feature values.

7. The system of claim 1, wherein to generate the query based on the set of feature values, the one or more processing devices are further to combine the set of feature values to generate the query or select one of the set of feature values to generate the query.

8. The system of claim 1, wherein the compensation data comprise at least one of a salary, a bonus, or an equity value.

9. The system of claim 1, wherein the compensation database comprises career progress histories of employees associated with one or more organizations, and wherein the one or more processing devices are further to:
determine, using a third neural network, stages in each of the career progress histories, wherein the stages are delimited by at least one of a job title change, a job skill change, or an employer change contained in a corresponding career progress history in a corresponding talent profile;
determine, from the compensation database, a history of compensation data over the stages for each of the career progress histories;
determine a compensation range based on the history of compensation data over the stages for the career progress histories; and
present, in the user interface, the compensation range.

10. The system of claim 9, wherein the compensation range comprises a plurality of compensation levels, wherein the one or more processing devices are further to:
determine, using the third neural network module, a probability value associated with each corresponding compensation level, the probability value indicating a likelihood for one of the plurality of matching candidates to accept an offer at the corresponding compensation level; and
present, in the user interface, the compensation range comprising the plurality of compensation levels and their corresponding probability values.

11. The system of claim 10, wherein the plurality of compensation levels comprise at least one of a predicted compensation level based on a predicted career progress at a future time.

12. The system of claim 1, wherein the one or more processing devices are further to:
monitor a talent profile database stored therein talent profiles of a plurality of employees of an organization;
responsive to determining a change in a first talent profile stored in the talent profile database, determine, using the neural network module, whether a compensation of a first employee characterized by the first talent profile deviates from a normal compensation range associated with the first talent profile; and
responsive to determining that the compensation of the first employee deviates from the normal compensation range, transmit a notification to a manager account.

13. A method for managing talent, the method comprising:
determining, by a processing device from a pool of applicants to a job opening, a plurality of matching candidates, wherein each of the plurality of matching candidates is characterized by a corresponding talent profile comprising one or more feature values, and wherein the job opening is characterized by a job profile comprising job requirements;
determining, using a neural network module, a set of feature values from the one or more feature values contained in the talent profiles associated with the plurality of matching candidates;
generating a query based on the set of feature values;
retrieving, based on the query, compensation data from a compensation database
presenting, in a user interface, the compensation data as part of potential offers to the plurality of matching candidates.

14. The method of claim 13, further comprising:
responsive to receiving an update to the job profile characterizing the job opening, determining, from the pool of applicants to the job opening, a second plurality of matching candidates;
determining, using the machine learning model, a second set of feature values from the one or more feature values contained in the talent profiles associated with the second plurality of matching candidates;
generating a second query based on the second set of feature values;
retrieving, based on the second query, second compensation data from a compensation database; and
presenting, in the user interface, the second compensation data.

15. The method of claim 13, wherein the one or more feature values comprise at least one of a job title, a team identifier, a project identifier, a job skill, or an education achievement, wherein the compensation database comprises compensation data compiled from one or more organizations, and wherein the compensation data comprise at least one of a salary, a bonus, or an equity value.

16. The method of claim 13, wherein determining, from a pool of applicants to a job opening, a plurality of matching candidates further comprises:
obtaining a second neural network module, wherein the second neural network module is trained by adjusting at least one parameter associated with the second neural network module using training talent profiles, and a training job profile; and
executing the second neural network module using talent profiles associated with the pool of applicants as first inputs and the job profile as a second input to determine the plurality of matching candidates for the job opening.

17. The method of claim 13, wherein determining, using a neural network module, a set of feature values from the one or more feature values contained in the talent profiles associated with the plurality of matching candidates further comprises:
obtaining the neural network module, wherein the neural network module is trained by adjusting at least one parameter associated with the neural network module using training feature values obtained from training talent profiles;
determining, using the neural network module, vectors of feature values from the one or more feature values contained in the talent profiles associated with the plurality of matching candidates;
determining, using a statistical model, one or more clusters of the vectors of feature values; and
determining, using a rule, a cluster of vectors of feature values, and determine the set of features based on the cluster of vectors of feature values.

18. The method of claim 13, wherein generating the query based on the set of feature values comprises combining the set of feature values to generate the query or selecting one of the set of feature values to generate the query.

19. The method of claim 13, wherein the compensation database comprises career progress histories of employees associated with one or more organizations, and the method further comprising:
determining, using a third neural network, stages in each of the career progress histories, wherein the stages are delimited by at least one of a job title change, a job skill change, or an employer change contained in a corresponding career progress history in a corresponding talent profile;
determining, from the compensation database, a history of compensation data over the stages for each of the career progress histories;
determining a compensation range based on the history of compensation data over the stages for the career progress histories; and
presenting, in the user interface, the compensation range.

20. The method of claim 19, wherein the compensation range comprises a plurality of compensation levels, and the method further comprising:
determining, using the third neural network module, a probability value associated with each corresponding compensation level, the probability value indicating a likelihood for one of the plurality of matching candidates to accept an offer at the corresponding compensation level; and
presenting, in the user interface, the compensation range comprising the plurality of compensation levels and their corresponding probability values, wherein the plurality of compensation levels comprise at least one of a predicted compensation level based on a predicted career progress at a future time.

21. The method of claim 13, further comprising:
monitoring a talent profile database stored therein talent profiles of a plurality of employees of an organization;
responsive to determining a change in a first talent profile stored in the talent profile database, determining, using the neural network module, whether a compensation of a first employee characterized by the first talent profile deviates from a normal compensation range associated with the first talent profile; and
responsive to determining that the compensation of the first employee deviates from the normal compensation range, transmitting a notification to a manager account.

22. A machine-readable non-transitory storage media encoded with instructions that, when executed by one or more processing devices, cause the one or more processing devices to implement a talent management platform, to:
determine, from a pool of applicants to a job opening, a plurality of matching candidates, wherein each of the plurality of matching candidates is characterized by a corresponding talent profile comprising one or more feature values, and wherein the job opening is characterized by a job profile comprising job requirements;
determine, using a neural network module, a set of feature values from the one or more feature values contained in the talent profiles associated with the plurality of matching candidates;
generate a query based on the set of feature values;
retrieve, based on the query, compensation data from a compensation database; and
present, in a user interface, the compensation data as part of potential offers to the plurality of matching candidates.
